(19) United States
(12) Patent Application Publication
(10) Pub. No.: US 2014/0338571 A1
(43) Pub. Date: Nov. 20, 2014

(54) AGGREGATES

(71) Applicant: Michael EVANS, (US)

(72) Inventor: Michael Evans, Worksop (GB)

(73) Assignee: NOVAGG LIMITED, Nottinghamshire (GB)

(21) Appl. No.: 14/368,337

(22) PCT Filed: Dec. 21, 2012
(86) PCT No.: PCT/GB2012/053249

§ 371 Date: Jun. 24, 2014

(30) Foreign Application Priority Data
Dec. 24, 2011 (GB) 1122431.8

(51) Int. Cl. C04B 18/02; C03C 11/00; C04B 18/10; C04B 38/02; C04B 18/06; C04B 18/30; C03C 10/00; C04B 41/50

(52) U.S. Cl. CPC C04B 18/027; C03C 10/0063; C03C 11/00; C04B 41/5027; C04B 38/02; C04B 18/06; C04B 18/305; C04B 18/10; C03C 2204/00
USPC 106/814; 501/32; 427/215; 427/220; 427/217; 264/43

(57) ABSTRACT

A method of forming an aggregate. The method comprising forming a green pellet including waste glass and additive(s). The unfired pellets are coated with a refractory material and sintered such that some of the additive/additives breaks down to generate gas which is at least partially retained in the microstructure of the mixture to form pores, the additive/additives so being that upon heating the additive/additives and glass combine to produce glass ceramics.

The present invention relates to aggregates for use in construction, particularly but not exclusively structural lightweight aggregates, to methods of producing aggregates, and to building materials comprising aggregates.

Conventionally, the term ‘aggregate’ denotes a particulate material (commonly as crushed rock, sand, gravel, or pebbles) which is added to a cementing agent to make a building material such as concrete.

Conventional concrete for use in structural applications commonly has a density in the region of 2200 to 2400 kg/m³. Such concrete is heavy, and can therefore be difficult and expensive to work with and transport. It is therefore desirable to produce a concrete that is less dense than conventional concrete, and yet still strong enough for use in construction. Such concretes are generally known as structural lightweight concretes.

A number of lightweight aggregates (LWA) for use in structural lightweight concretes have been proposed. However many of these have disadvantages such as being difficult or expensive to produce. A method for producing an alternative lightweight aggregate is therefore desirable.

In this specification the term “slag material” is to be understood as covering any non metallic by-product of metal smelting. In particular, this term covers processed aluminium salt slag (PASS), ferro-silicon slag (FESI), silicone industry waste materials, and steel and iron work slag.

In this specification the term “green pellet” is understood as covering pellets which have not been fired.

According to a first aspect of the present invention there is provided a method for preparing an aggregate comprising a plurality of particles, the method comprising forming a mixture comprising glass powder and an additive, forming green pellets from the mixture, coating the surface of the pellets with a refractory material and heating the pellets at a required temperature to produce a plurality of particles, the additive being such that it at least partially breaks down at the required temperature to generate gas, which gas is at least partially retained in the microstructure of the mixture to cause the formation of pores within the microstructure, the additive also being such that upon heating the additive and glass combine to produce a glass ceramic system.

The additive may include a slag material. The slag material may include processed aluminium salt slag (PASS), ferro-silicon slag (FESI), silicone industry waste materials, steel and Iron work slag, or siloxane waste.

The additive may include one or more additional components. The additional components may be such that they at least partially break down at the required temperature to generate gas. The additional components may be such that upon heating they combine with the glass to produce a glass ceramic system.

The processed aluminium salt slag may comprise 65-70% aluminium oxide by weight, 12-20% water by weight and 0.5-1% chloride by weight.

The additive may include a waste stream. Possible, waste streams include incinerated sewage sludge ash (ISSA), incinerated paper sludge ash (IPSA), various types of waste quarry fines, perlite waste, pulverised fuel ash (PFA) and contaminated soils and waste paint. The incinerated sewage sludge ash may contain fluxes.

The additive may include clay.

The additional components may include any of a binding agent, a soluble flux material, a strengthening agent, a bloating agent, a plasticiser, an iron rich substance, and a material capable of containing heavy metals.

Closed pores (i.e. voids or bubbles, generally of gas) are formed within the aggregate particles as the additive in the mixture expands during heating. An aggregate comprising such particles is thus lighter in weight than an aggregate comprising particles of similar material and comparable size which do not comprise closed pores.

The method may further comprise the step of introducing (e.g. mixing) the aggregate particles into a settable matrix to produce a building material.

The method may further include the step of using the building material in the construction of an object or structure.

Using glass powder means that particles produced by the method are substantially vitreous, and hence impermeable to liquid. This is particularly useful when the aggregate is used as part of a building material, such as concrete. Because the impermeable particles hold little water, the LWA does not need substantial pre-wetting before use in concrete mixtures and the building material dries more quickly than a building material comprising similar but permeable particles.

Preferably the glass powder comprises glass particles substantially having a maximum dimension which is less than 75 μm (for example, 95% by volume of the particles should have a dimension which is less than 70 μm).

The glass powder may have a working range at which the glass powder softens at between 750 and 900° C. The glass powder may be a soda lime silica glass, which may conveniently be ground from waste glass.

The mixture may comprise between 60 and 95% glass by weight, and for instance may include between 70 and 80% glass by weight.

The additional components may include a binding agent, such as water, and preferably comprise as little water as possible to plasticise the mixture. The green pellets may comprise between 30% and 10% water by weight.

The additional components may include a soluble flux and/or strengthening agent, such as sodium silicate or potassium silicate, for example a sodium silicate solution, which may comprise substantially 60% sodium silicate and 40% water by weight. The pellets may comprise up to 5% sodium silicate solution by weight, for example 4%, 3% or 2%, and preferably comprise substantially 1% sodium silicate solution.

The additional components may include a bloating agent. The mixture may comprise between 0.25 and 5% bloating agent by weight. The bloating agent is added to give the desirable degree of bloat to achieve the intended LWA density and microstructure.

The bloating agent may be in the form of a carbonaceous material, for example, anthracite fines, coke fines, coal, carbon black, tyre crumb, high carbon content materials or wastes, and carbonates such as calcium magnesium carbonate or calcium carbonate. The bloating agent may be in the form of a fibrous carbonaceous material.

The bloating agent may be in the form of dolomitic limestone. Dolomitic limestone contains dolomite which is calcium magnesium carbonate. During the heating process carbonates may produce carbon dioxide.

Fibre rich material may also be added as this provides a calorific input. This may comprise up to 5% of a fibre rich material by weight such as paper or cardboard waste, which may be shredded. The fibre may be a cellulose fibre. The fibre additive may increase the strength of the green pellets and assist with egress of moisture during the drying and firing process.

The fibre additive may provide a calorific input.

The additional components may include water treatment residues (WTR). The WTR may be aluminium or iron-based. The water treatment residue may have a moisture content of between 60% and 70% by weight. The water treatment residue may be an organic residue extracted during the process of purification of drinking water. The water treatment residue may act as a plasticiser.

The additional components may include waste sugar, and/or anthracite and/or other carbon rich streams. Waste sugar, anthracite and other carbon rich streams may assist in the bloating process. Waste sugar, anthracite and other carbon rich streams may have a high calorific value which may lower firing costs.

The additional components may include micro-silica, which micro-silica may assist in the containment of heavy metals.

The mixture may further comprise one or more additional components, selected from the group phosphates and borates. The phosphates and borates may be fluxing agents.

The additional components may comprise between 0.5% and 10% of phosphates and/or borates by weight.

The additional components may comprise iron-rich substances, in particular iron-rich waste streams, for example electric arc furnace dust (EAFD) and/or lead-rich waste stream. The mixture may comprise between 5% and 40% iron-rich and/or lead rich substances by weight.

The step of forming the mixture into green pellets may comprise at least one of pelletising, extruding or pressing the pellets from the mixture.

The step of forming may comprise aggregating the pellets, for example by mixing, such as in a planetary mixer.

Treating the surface of the green pellets with the refractory coating reduces the stickiness of the surface of a treated pellet in comparison with an untreated pellet and may increase the surface roughness to facilitate binding with cement in concrete. Treating the pellets with the refractory coating may occur after pelletisation. The refractory material may be limestone dust, silica dust, iron dust and/or china clay, ball clay, calcium oxide, dolomite or other refractory powders. The refractory coating may comprise less than 2% of the pellet by weight, and preferably less than 1% of the pellet by weight.

The refractory material may assist in absorbing potentially harmful gases emitted during the firing process.

The pellets may be pre-heated at 110° C. to drive off mechanically held water.

The step of sintering may comprise heating the pellets in a kiln, for example a rotary kiln. The pellets may be heated to a maximum temperature which is less than 1000° C., and may be heated to a maximum temperature within the range of 700 to 950° C., and may be 700 to 850° C. and may be 750 to 800° C.

The pellets may be heated to the maximum temperature rapidly, for example the pellets may be heated to the maximum temperature in between 10 and 60 minutes.

The pellets may be maintained at the maximum temperature for less than 40 minutes, for example between 5 and 15 minutes, and preferably for substantially 10 minutes.

The process of rapidly heating pellets to a high temperature and maintaining that temperature for a short period of time is commonly referred to as “flash firing”.

During this time the glass softens/partly melts, the additives thermally decompose and volatilise to evolve gasses and the additives form the intended glass ceramic. The rapid heating of the pellets ensures that the pellet begins to vitrify concomitantly with the evolution of gasses. As a result a proportion of the gas is trapped within the vitrified structure creating a plurality of closed voids.

The fired pellets may be cooled. The cooling rate may be varied.

Controlled cooling of the fired pellets prevents crystallization leaving the desired amorphous structure and achieving the desired microstructure in the glass ceramic LWA product.

According to a second aspect of the invention there is provided a method of producing green pellets, the method including the steps of forming a plurality of green pellets from a mixture comprising glass powder, and an additive, and a refracting material coating.

The mixture may comprise a dry mixture including glass in the range 0-95% by weight (which may be milled to 95% minus 200 mesh (<74 μm)), and additives in the range 5-30% by weight.

Water in the range 10-30% water by weight may be added to the dry mixture, to produce a plastic mixture.

Sodium silicate in the range 0.5-5.0% by weight may be added to the mixture.

One or more iron-rich substances (for example electric arc furnace dust) may be included in the mixture, for example between 5 and 30% by weight.

Further chemicals such as one or more of phosphates and borates in the range 0.5-10% by weight may be added to the mixture.

The mixture may comprise a bloating agent, such as a carbonaceous material or dolomitic limestone, in the range 0.25-5% by weight. The bloating agent may be an additive.

The plastic mixture may be pelletised.

The refractory coating may be one or more of limestone dust, silica dust, iron dust, china clay, ball clay, calcium oxide, dolomite or other refractory powders, may be added to the plastic mixture before, during, or after pelletisation, but preferably during pelletisation. The refractory coating may comprise less than 2% of the pellet by weight.

The resulting green pellets may be substantially spherical, and may comprise a refractory coating.

According to a third aspect of the invention there is provided a method for preparing an aggregate particle, the method comprising sintering a green pellet in accordance with the second aspect of the invention so as to cause the pellet to expand to produce a particle comprising a plurality of internal closed pores.

The method may comprise sintering the green pellet in a kiln, such as a rotary kiln, as described above. In particular, the pellets may be heated to a maximum temperature which is less than 1000° C., and may be heated to a maximum temperature within the range of 700 to 1000° C., for example 850° C. or 950° C. A reducing atmosphere may be created in which localised reduction of various oxides of iron within the pellet in the presence of carbon may occur. Heavy metals may be absorbed.

The resulting particle may be a substantially impermeable vitreous particle having a plurality of closed internal pores. The resulting particle may have a larger diameter than the original green pellet from which it was formed. The closed pores may have a largest dimension which is approximately 100 μm or less. The particle may have a substantially impermeable vitreous outer layer. The resulting particle may be light, may be very strong and may have a low water absorption.

The resulting particle may have a core. The core may be vitreous and glassy and may have a closed pore non-connected micro structure. The core may be iron rich. The core may have a mineral composition substantially comprising magnetite (Fe₃O₄). The core may extend to an outer skin of the pellet. The core may have significantly enhanced strength. A Staffordshire Blue brick effect may be achieved.

According to a fourth aspect of the invention there is provided a pellet produced by the method of the second aspect of the invention, the pellet comprising glass and an additive, and an outer refractory coating.

According to a fifth aspect of the invention there is provided an aggregate comprising a particle having a plurality of closed pores, the particle being sintered from a mixture of glass and an additive, with an outer refractory coating.

The particle may be produced by one or more of the methods of the first to third aspect of the invention, and may comprise glass and an additive, and possibly additional components in the proportions discussed above.

The particle may be substantially vitreous. The particle may comprise a substantially impermeable outer surface.

According to a sixth aspect of the invention there is provided a building material comprising a settable matrix and a plurality of particles in accordance with the fifth aspect of the invention.

The settable matrix may comprise a cementing agent. The building material may comprise concrete.

According to a seventh aspect of the invention there is provided an object formed of the building material of the sixth aspect of the invention.

The present invention will now be described, by way of a number of examples only:

### EXAMPLE 1

### Dry Mixture:

100 parts waste glass (milled to 95% minus 200 mesh—74 micron)
30 parts processed aluminium salt slag (no grinding)
1% anthracite by weight
1% sodium silicate by weight (75 TW)

### Plastic Mixture (Green Pellet Composition):

Dry mixture
Water to achieve a moisture content of 12% by weight

The above mixture is intimately mixed to form a semi-stiff workable plastic mixture. A green pellet is formed by hand rolling, for example 1 or 2 g of the plastic mixture into a pellet.

The green pellets are coated with a refractory material.

The green pellets are placed onto a ceramic fibre based Batt and quickly placed into a laboratory kiln pre-heated to 750° C. The Kiln is allowed to return to 750° C., at which point the pellets are fired for 15 minutes. After 15 minutes the heat treated particles are removed from the kiln and allowed to cool.

Analysis indicates that the resulting particles have a water content of less than 7% by weight, and a density range from 1 to 1.1 g/cc.

### EXAMPLE 2

### Dry Mixture:

100 parts waste glass (milled to 95% minus 200 mesh—74 micron)
40 parts processed aluminium salt slag (no grinding)
1% anthracite by weight
1% sodium silicate by weight (75 TW)

### Plastic Mixture (Green Pellet Composition):

Dry mixture
Water to achieve a moisture content of 12% by weight

The above mixture is intimately mixed to form a semi-stiff workable plastic mixture. A green pellet is formed by hand rolling, for example 1 or 2 g of the plastic mixture into a pellet.

The green pellets are coated with a refractory material.

The green pellets are placed onto a ceramic fibre based Batt and quickly placed into a laboratory kiln pre-heated to 750° C. The Kiln is allowed to return to 750° C., at which point the pellets are fired for 15 minutes. After 15 minutes the heat treated particles are removed from the kiln and allowed to cool.

Analysis indicates that the resulting particles have a water content of less than 7% by weight, and a density range from 1.2 to 1.4 g/cc.

### EXAMPLE 3

Dry Mixture:
100 parts waste glass (milled to 95% minus 200 mesh—74 micron)
30 parts processed aluminium salt slag (no grinding)
10 parts electric arc furnace dust
1% anthracite by weight
1% sodium silicate by weight (75 TW)

### Plastic Mixture (Green Pellet Composition):

Dry mixture
Water to achieve a moisture content of 12% by weight

The above mixture is intimately mixed to form a semi-stiff workable plastic mixture. A green pellet is formed by hand rolling, for example 1 or 2 g of the plastic mixture into a pellet.

The green pellets are coated with a refractory material.

The green pellets are placed onto a ceramic fibre based Batt and quickly placed into a laboratory kiln pre-heated to 750° C. The Kiln is allowed to return to 750° C., at which point the pellets are fired for 15 minutes. After 15 minutes the heat treated particles are removed from the kiln and allowed to cool.

Analysis indicates that the resulting particles have a water content of less than 7% by weight, and a density of 0.8 g/cc.

### EXAMPLE 4

### Dry Mixture:

100 parts waste glass (milled to 95% minus 200 mesh—74 micron)
30 parts processed aluminium salt slag (No Grinding)
10 parts incinerated sewage sludge ash
1% anthracite by weight
1% sodium silicate by weight (75 TW)

### Plastic Mixture (Green Pellet Composition):

Dry mixture
Water to achieve a moisture content of 12% by weight

The above mixture is intimately mixed to form a semi-stiff workable plastic mixture. A green pellet is formed by hand rolling, for example 1 or 2 g of the plastic mixture into a pellet.

The green pellets are coated with a refractory material.

The green pellets are placed onto a ceramic fibre based Batt and quickly placed into a laboratory kiln pre-heated to 750° C. The Kiln is allowed to return to 750° C., at which point the pellets are fired for 15 minutes. After 15 minutes the heat treated particles are removed from the kiln and allowed to cool.

Analysis indicates that the resulting particles have a water content of less than 7% by weight, and a density of 1.4 g/cc.

### EXAMPLE 5

### Dry Mixture:

100 parts waste glass (milled to 95% minus 200 mesh—74 micron)

10 parts incinerated news print

1% anthracite by weight

1% sodium silicate by weight (75 TW)

### Plastic Mixture (Green Pellet Composition):

Dry mixture
Water to achieve a moisture content of 12% by weight

The above mixture is intimately mixed to form a semi-stiff workable plastic mixture. A green pellet is formed by hand rolling, for example 1 or 2 g of the plastic mixture into a pellet.

The green pellets are coated with a refractory material.

The green pellets are placed onto a ceramic fibre based Batt and quickly placed into a laboratory kiln pre-heated to 750° C. The Kiln is allowed to return to 750° C., at which point the pellets are fired for 15 minutes. After 15 minutes the heat treated particles are removed from the kiln and allowed to cool.

Analysis indicates that the resulting particles have a water content of less than 10% by weight, and a density of 0.33 g/cc.

### EXAMPLE 6

### Dry Mixture:

100 parts waste glass (milled to 95% minus 200 mesh—74 micron)
30 parts processed aluminium salt slag (no grinding)
20 parts electric arc furnace dust
1% anthracite by weight
1% sodium silicate by weight (75 TW)

### Plastic Mixture (Green Pellet Composition):

Dry mixture
Water to achieve a moisture content of 12% by weight

The above mixture is intimately mixed to form a semi-stiff workable plastic mixture. A green pellet is formed by hand rolling, for example 1 or 2 g of the plastic mixture into a pellet.

The green pellets are coated with a refractory material.

The green pellets are placed onto a ceramic fibre based Batt and quickly placed into a laboratory kiln pre-heated to 750° C. The Kiln is allowed to return to 750° C., at which point the pellets are fired for 15 minutes. After 15 minutes the heat treated particles are removed from the kiln and allowed to cool.

Analysis indicates that the resulting particles have a water content of less than 7% by weight, and a density of 0.8 g/cc.

It is to be realised that a wide range of other proportions of components and/or other additives might also be included if required.

A soluble flux, such as approximately 1% sodium silicate by weight, may be added to the mixture to improve the strength of the green pellets. At this stage, other components (up to 10% by weight) might also be introduced into the mix, such as iron oxide, phosphates, and borates, if required (for example, to increase the strength of the finished particles).

The borates may act as fluxing agents and may assist in fixing hazardous elements such as chromium, selenium, molybdenum, zinc and lead.

The plastic mixture may be formed into pellets using any suitable method, such as using a planetary mixer. The refractory material coating helps to prevent the pellets from agglomerating when heated.

The pellets are substantially spherical, with suitable minor imperfections in the form of surface roughness, angularities and unevenness. The surface of each of the pellets is substantially smooth, due to the tumbling experienced by the pellets in the mixer. The pellets produced by the method may vary in size, and are screened to select those having a diameter in a desired range, for example between 0.5 and 1 cm.

As the green pellets are heated, the sintering causes the components of the mixture to fuse and the pellets to expand. The expansion is assisted by combustion and/or gas generation of the bloating agent in the mixture, causing the pellet to expand and a plurality of closed pores to be formed within the pellet.

The refractory coating fuses with the pellet while it remains at high temperatures. The resulting sintered particle has a hard substantially vitreous body including a plurality of closed pores and a substantially impermeable outer layer. The particle is generally spherical, having a diameter of between 5 and 50% larger than the green pellet from which it was formed.

The sintered particle has a density of between 300 and 1600 Kg/m3. The sintered particle has a packing density of between 800 to 1200 Kg/m3. The sintered particle has a crushing strength of between 1 and 5 N/mm2. The sintered particle has a 24-hour water absorption (dry basis) of between 2 and 12% by weight.

The amount of expansion that the pellet experiences during sintering is affected by the green pellet composition and temperature at which the sintering occurs. Sintering an optimised composition at a required temperature and for a required time will cause the desired expansion. However, sintering above a certain critical temperature can result in a particle with too high a density. Over firing can result in the pellet shrinking and/or melting which results in an increase in pellet density above the desired level. Under firing will result in a pellet of above target density and lacking in strength.

The amount of expansion that a pellet experiences is also affected by the carbon content of the pellet. As the carbonaceous content of the pellet is burnt away during sintering, gas is produced, which causes some expansion of the pellet.

It has been found that a pellet having a carbon content of between 0.25 and 3% by weight is particularly successful in producing a particle which is light but strong. The carbon content may be introduced to the green mixture as a separate component (for example, as a dust or fibrous material).

A particle of the type described above is lighter in weight than an entirely solid particle of similar size, due to the presence of the closed pores. This makes the particle particularly useful as a lightweight aggregate for use in construction, and particularly as a component of a lightweight concrete. The particle might also be useful as a component of thermal or sound insulation, due to the insulating properties of the closed voids.

The vitreous structure of the outer layer of the particle and the closed pore core means that the particle absorbs little water. In particular, the outer layer of the particle is a substantially closed surface. This is advantageous, as a concrete including substantially impermeable particles has better control of workability and dries more quickly in use than a concrete including permeable particles. Even if one or more of the pores should happen to terminate on the surface of the particle, water cannot penetrate far into the body of the particle, because the boundary of each pore is itself formed by impermeable vitreous material.

A method is therefore described for manufacturing engineered lightweight aggregate (LWA) with tailored properties using controlled, optimised, pre-determined mixtures of novel or innovatively processed waste/secondary raw materials that are subsequent rapidly sintered, at low temperature compared to conventional LWA manufacturing. This produces a LWA product with a variety of specifications, but preferably with very low water absorption, density in the range between 0.33 and 1.60 g/cc and high compressive strength, with these properties achieved by the incorporation of wastes that are rich in Al₂O₃ and/or Fe₂O₃.

The disposal of waste streams is both expensive and damaging to the environment. The claimed method for producing a lightweight aggregate can be easily adapted to include a diverse range of waste streams. Such waste streams are incorporated within the aggregate, the structure of which prevents toxins from leaching back into the environment. The method therefore also represents a cost effective remedy for reusing toxic waste materials that otherwise would be expensive and environmentally damaging to dispose of.

Whilst endeavouring in the foregoing specification to draw attention to those features of the invention believed to be of particular importance it should be understood that the applicant claims protection in respect of any patentable feature or combination of features hereinbefore referred to and/or shown in the drawings whether or not particular emphasis has been placed thereon.

1. A method for preparing an aggregate comprising a plurality of particles, the method comprising forming a mixture comprising glass powder and an additive, forming green pellets from the mixture, coating the surface of the pellets with a refractory material and heating the pellets at a required temperature to produce a plurality of particles, the additive being such that it at least partially breaks down at the required temperature to generate gas, which gas is at least partially retained in the microstructure of the mixture to cause the formation of pores within the microstructure, the additive also being such that upon heating the additive and glass combine to produce a glass ceramic system.

2. A method according to claim 1, characterised in that the additive includes any of: a slag material; clay; a waste stream.

3-4. (canceled)

5. A method according to claim 1, characterised in that the additive includes one or more of any of the following additional components:
a binding agent; a soluble flux material; a strengthening agent, a bloating agent, a plasticiser, an iron rich substance; a material capable of containing heavy metals; a binding agent; a soluble flux; strengthening agent; a bloating agent; water treatment residues (WTR); waste sugar; micro silica; phosphates; borates.

6. A method according to claim 5, characterised in that the additional components are such that they at least partially break down at the required temperature to generate gas.

7. A method according to claim 5, characterised in that the additional components are such that upon heating they combine with the glass to produce a glass ceramic system.

8-10. (canceled)

11. A method according to claim 2, characterised in that the waste stream includes any of incinerated sewage sludge ash (ISSA), incinerated paper sludge ash (IPSA), various types of waste quarry fines, perlite waste, pulverised fuel ash (PFA) and contaminated soils and waste paint.

12. (canceled)

13. A method according to claim 1, characterised in that the method further comprises the step of introducing (e.g. mixing) the aggregate particles into a settable matrix to produce a building material.

14. (canceled)

15. A method according to claim 1, characterised in that the glass powder comprises glass particles substantially having a maximum dimension which is less than 75 μm.

16-18. (canceled)

19. A method according to claim 1, characterised in that the mixture includes between 60 and 95% glass by weight.

20-51. (canceled)

52. A method according to claim 1, characterised in that the step of forming the mixture into green pellets comprises at least one of pelletising, extruding or pressing the pellets from the mixture.

53-54. (canceled)

55. A method according to claim 1, characterised in that coating the pellets with a refractory material occurs after pelletisation.

56. A method according to claim 1, characterised in that the refractory material is any of limestone dust, silica dust, iron dust and/or china clay, ball clay, calcium oxide, dolomite or other refractory powders.

57-58. (canceled)

59. A method according to claim 1, characterised in that the pellets are pre-heated at 110° C. to drive off mechanically held water.

60-61. (canceled)

62. A method according to claim 1, characterised in that the pellets are heated within the range 700 to 950° C.

63-64. (canceled)

65. A method according to claim 1, characterised in that the pellets are heated to the maximum temperature for between 10 and 60 minutes.

66-69. (canceled)

70. A method of producing green pellets, the method including the steps of forming a plurality of green pellets from a mixture comprising glass powder, and an additive, and a refractory material coating.

71. A method according to claim 70, characterised in that the mixture comprises a dry mixture including glass in the range 0-95% by weight and additives in the range 5-30% by weight.

72-82. (canceled)

83. A method for preparing aggregate particles, the method comprising forming a plurality of green pellets from a mixture comprising glass powder, and an additive, and a refractory material coating, sintering the green pellets so as to cause the pellets to expand to produce particles comprising a plurality of internal closed pores.

84-88. (canceled)

89. A method according to claim 83, characterised in that a reducing atmosphere is created during sintering in which localised reduction of various oxides of iron within the pellet in the presence of carbon may occur.

90-98. (canceled)
